(19) United States
(12) Patent Application Publication
(10) Pub. No.: US 2018/0065418 A1
(43) Pub. Date: Mar. 8, 2018

(54) PNEUMATIC TIRE

(71) Applicant: TOYO TIRE & RUBBER CO., LTD., Osaka (JP)

(72) Inventor: Sachio Sakamoto, Osaka-shi (JP)

(73) Assignee: TOYO TIRE & RUBBER CO., LTD., Osaka (JP)

(21) Appl. No.: 15/492,519

(22) Filed: Apr. 20, 2017

(30) Foreign Application Priority Data
Sep. 7, 2016 (JP) 2016-174686
Sep. 7, 2016 (JP) 2016-174693

(51) Int. Cl. B60C 13/02; B60C 11/01

(52) U.S. Cl. CPC B60C 13/02; B60C 11/01

(57) ABSTRACT

In a pneumatic tire, at least one of a plurality of projecting portions includes at least one opening. At least one of the projecting portions is divided into an inner region placed on inner side in a tire radial-direction and an outer region placed on outer side in the tire radial-direction with respect to a position of an outer end of the belt play in a tire width-direction, the belt play placed on the innermost side in the tire radial-direction. A total sum of an opening area of the opening in the outer region is different from a total sum of an opening area of the opening in the inner region.

### CROSS REFERENCE TO RELATED APPLICATIONS

This application claims the benefit of priority of Japanese application no. 2016-174686, filed on Sep. 7, 2016, and Japanese application no. 2016-174693, filed on Sep. 7, 2016, which are incorporated herein by reference.

### BACKGROUND OF THE INVENTION

### Field of the Invention

The present invention relates to a pneumatic tire having a plurality of projecting portions which project in a tire width-direction.

### Description of the Related Art

There are conventionally known pneumatic tires each having a plurality of projecting portions which project in a tire width-direction (e.g., JP-A-2010-264962). According to a structure of this pneumatic tire, traction performance on a mud area or a rocky area is enhanced due to resistance caused when the projecting portions shear dirt and due to friction between the projecting portions and rock, and resistance to external damage is enhanced, due to increase in rubber thickness.

By the way, weight balance of the tire is prone to become uneven due to existence of the projecting portions. Accordingly, when the tire is produced (vulcanized), rubber does not smoothly flow, the tire maybe chipped (bare may be generated) with respect to a desired tire shape, or uniformity may foe lowered and this may cause vibration or noise of a vehicle.

### SUMMARY OF INVENTION

It is an object of the present invention to provide a pneumatic tire capable of suppressing unevenness of weight balance.

There is provided a pneumatic tire, which includes:

a sidewall portion extending in a tire radial-direction; and

a tread portion having a tread surface on an outer side in the tire radial-direction and connected to an outer end of the sidewall portion in the tire radial-direction, wherein

the tread portion includes a tread rubber placed on the outer side in the tire radial-direction, and at least one belt ply placed on an inner side of the tread rubber in the tire radial-direction,

the tread rubber includes a plurality of grooves extending to an outer end in a tire width-direction, and a plurality of blocks arranged in a tire circumferential-direction by feeing defined by the plurality of grooves,

the sidewall portion includes a plurality of projecting portions projecting in the tire width-direction,

the projecting portions are placed such that at least portions of the projecting portions are superposed on one of the plurality of blocks in the tire radial-direction as viewed from the tire width-direction,

at least one of the plurality of projecting portions includes at least one opening,

at least one of the projecting portions is divided into an inner region placed on the inner side in the tire radial-direction and an outer region placed on the outer side in the tire radial-direction with respect to a position of an outer end of the belt play in the tire width-direction, wherein the belt play placed on the innermost side in the tire radial-direction, and

a total sum of an opening area of the opening in the outer region is different from a total sum of an opening area of the opening in the inner region.

Also, the pneumatic tire may have a configuration in which:

the total sum of the opening area of the opening in the outer region is greater than the total sum of the opening area of the opening in the inner region.

Also, the pneumatic tire may have a configuration in which:

in a ratio of the total sums of the opening areas of the opening with respect to an actual area of the projecting portion, the ratio of the outer region is greater than the ratio of the inner region.

Also, the pneumatic tire may have a configuration in which:

a depth of the opening in the outer region is greater than a depth of the opening in the inner region.

Also, the pneumatic tire may have a configuration in which:

a projecting amount of the projecting portion in the outer region is greater than a projecting amount of the projecting portion in the inner region.

Also, the pneumatic tire may have a configuration in Which:

the total sum of the opening area of the opening in the inner region is greater than the total sum of the opening area of the opening in the outer region.

Also, the pneumatic tire may have a configuration in which:

in a ratio of the total sums of the opening areas of the opening with respect to an actual area of the projecting portion, the ratio of the inner region is greater than the ratio of the outer region.

Also, the pneumatic tire may have a configuration in which:

a depth of the opening in the inner region is greater than a depth of the opening in the outer region.

Also, the pneumatic tire may have a configuration in which:

a projecting amount of the projecting portion in the inner region is greater than a projecting amount of the projecting portion in the outer region.

Also, there is provided a pneumatic tire, which includes:

a sidewall portion extending in a tire radial-direction; and

a tread portion having a tread surface on an outer side in the tire radial-direction and connected to an outer end of the sidewall portion in the tire radial-direction, wherein

the tread portion includes a tread rubber placed on the outer side in the tire radial-direction, and at least one belt ply placed on an inner side of the tread rubber in the tire radial-direction,

the tread rubber includes a plurality of grooves extending to an outer end in a tire width-direction, and a plurality of blocks arranged in a tire circumferential-direction by being defined by the plurality of grooves,

the side-wall portion includes a plurality of projecting portions projecting in the tire width-direction,

the projecting portions are placed such that at least portions of the projecting portions are superposed on one of the plurality of blocks in the tire radial-direction as viewed from the tire width-direction,

at least one of the plurality of projecting portions includes at least one opening,

at least one of the projecting portions is divided into an inner region placed on the inner side in the tire radial-direction and an outer region placed on the outer side in the tire radial-direction with respect to a position of an outer end of the belt play in the tire width-direction, wherein the belt play placed on the innermost side in the tire radial-direction, and

the total sum of the opening area of the opening in the outer region is equal to or greater than the total sum of the opening area of the opening in the inner region.

Also, there is provided a pneumatic tire, which includes:

a sidewall portion extending in a tire radial-direction; and

a tread portion having a tread surface on an outer side in the tire radial-direction and connected to an outer end of the sidewall portion in the tire radial-direction, wherein

the tread, portion includes a tread rubber placed on the outer side, in the tire radial-direction, and at least one belt ply placed on an inner side of the tread rubber in the tire radial-direction,

the tread rubber includes a plurality of grooves extending to an outer end in a tire width-direction, and a plurality of blocks arranged in a tire circumferential-direction by being defined by the plurality of grooves,

the sidewall portion includes a plurality of projecting portions projecting in the tire width-direction,

the projecting portions are placed such that at least portions of the projecting portions are superposed on one of the plurality of blocks in the tire radial-direction as viewed from the tire width-direction,

at least one of the plurality of projecting portions includes at least one opening,

at least one of the projecting portions is divided into an inner region placed on the inner side in the tire radial-direction and an outer region placed on the outer side in the tire radial-direction with respect to a position of an outer end of the belt play in the tire width-direction, wherein the belt play placed on the innermost side in the tire radial-direction, and

the total sum of the opening area of the opening in the inner region is equal to or greater than the total sum of the opening area of the opening in the outer region.

### BRIEF DESCRIPTION OF THE DRAWINGS

FIG. 1 is a sectional view of essential portions of a tire meridional plane of a pneumatic tire of an embodiment;

FIG. 2 is a front view (as viewed from tire radial-direction) of the pneumatic tire of the embodiment;

FIG. 3 is a side view (as viewed from tire width-direction) of the pneumatic tire of the embodiment;

FIG. 4 is an enlarged sectional view of essential portions taken along line IV-IV of FIG. 3;

FIG. 5 is a sectional view of essential portions of the tire meridional plane of the pneumatic tire of the embodiment, and is a view showing a shape when the tire comes into contact with the ground;

FIG. 6 is a diagram showing a region of an opening area of an opening in an inner region of the embodiment;

FIG. 7 is a diagram showing a region of an opening area of an opening in an outer region of the embodiment;

FIG. 8 is a diagram showing a region of an actual surface area of a projecting portion in the inner region of the embodiment;

FIG. 9 is a diagram shoving a region of an actual surface area of the projecting portion in the outer region of the embodiment;

FIG. 10 is a diagram showing a projecting portion of a modification of the embodiment;

FIG. 11 is a diagram showing a projecting portion of another modification of the embodiment;

FIG. 12 is a diagram showing a projecting portion of another modification of the embodiment;

FIG. 13 is a diagram showing a projecting portion of another modification of the embodiment;

FIG. 14 is a front view (as viewed from tire radial-direction) of essential portions of a pneumatic tire of another embodiment;

FIG. 15 is a side view (as viewed from tire width-direction) of essential portions of the pneumatic tire of the embodiment;

FIG. 16 is an enlarged sectional view of essential portions taken along line XVI-XVI of FIG. 15;

FIG. 17 is a sectional view or essential portions of the tire meridional plane of the pneumatic tire of the embodiment, and is a view showing a shape when the tire comes into contact with the ground;

FIG. 18 is a diagram showing a region of an opening area of an opening in an inner region of the embodiment;

FIG. 19 is a diagram showing a region of an opening area of an opening in an outer region of the embodiment;

FIG. 20 is a diagram showing a region of an actual surface area of a projecting portion in the inner region of the embodiment;

FIG. 21 is a diagram showing a region of an actual surface area of a projecting portion in the outer region of the embodiment;

FIG. 22 is a diagram showing projecting portions of a modification of the embodiment;

FIG. 23 is a diagram showing projecting portions of another modification of the embodiment;

FIG. 24 is a diagram showing projecting portions of another modification of the embodiment; and

FIG. 25 is a diagram showing projecting portions of another modification of the embodiment.

### DETAILED DESCRIPTION OF THE PREFERRED EMBODIMENTS

<First Embodiment>

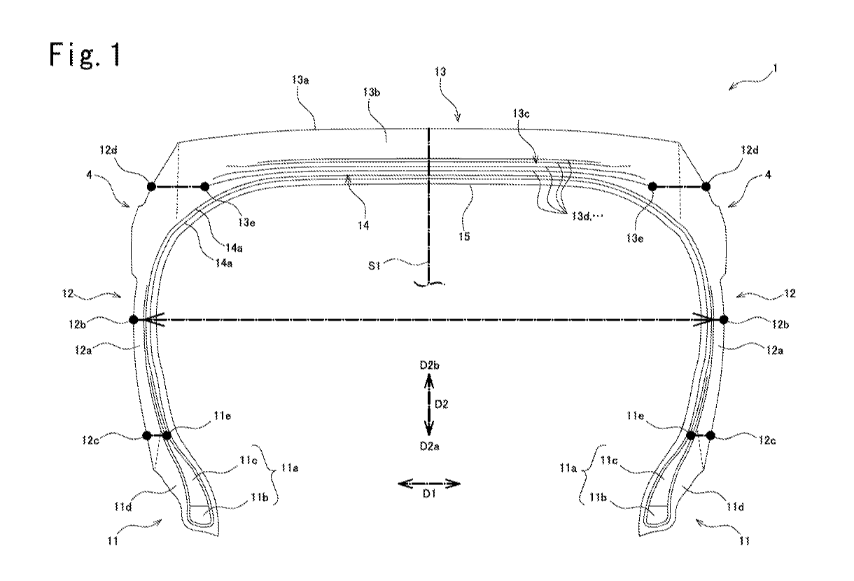

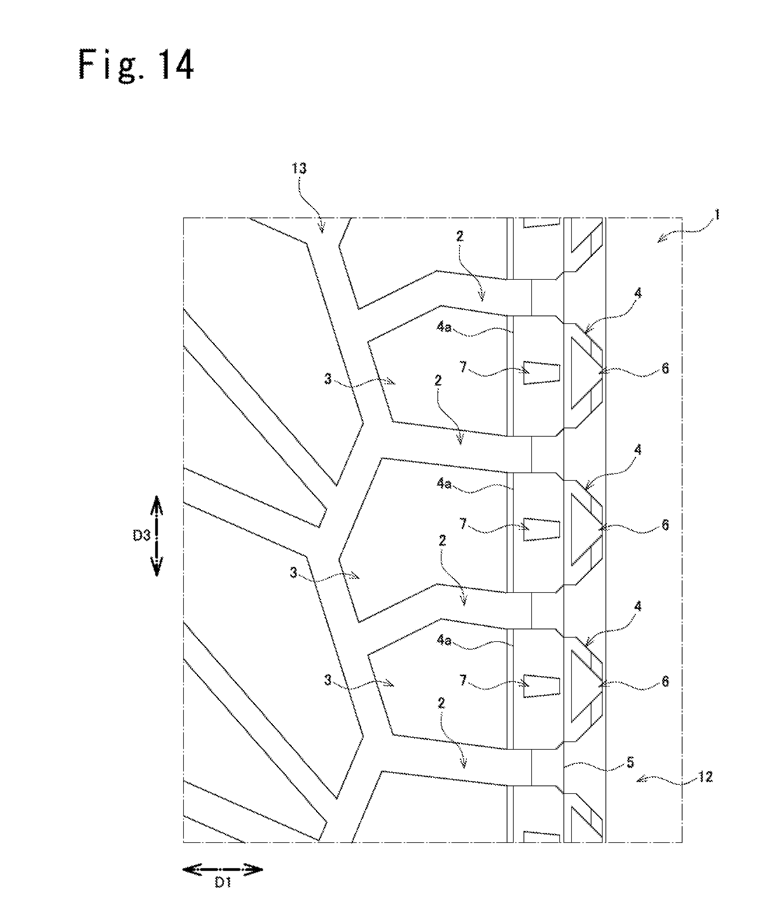

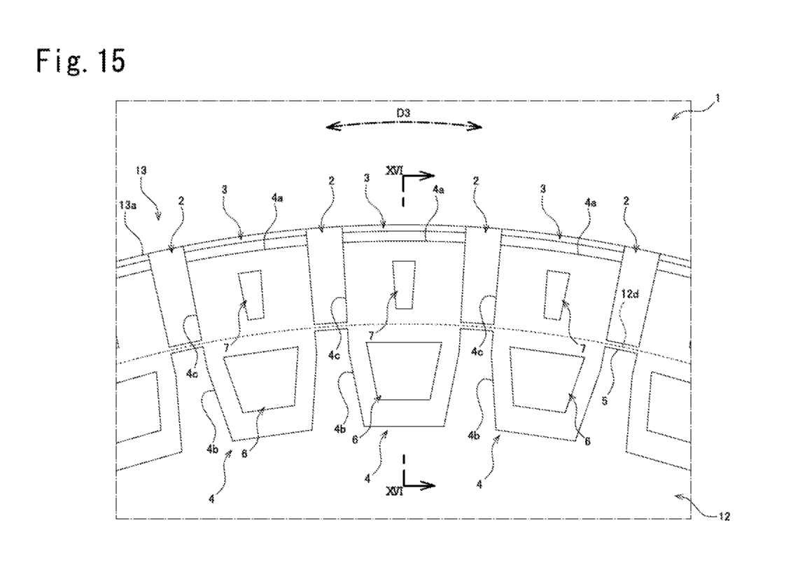

A pneumatic tire of a first embodiment will be described below with reference to FIGS. 1 to 13. Size ratios in each of the drawings (including FIGS. 14 to 25) do not always match with actual size ratios, and size ratios between the drawings do not always match with each other.

As shown in FIG. 1, the pneumatic tire (also called “tire” simply) 1 includes a pair of bead portions 11 having beads 11a. The tire 1 includes sidewall portions 12 extending from the bead portions 11 radially outward in a tire radial-direction D2, and a tread portion 13 which is connected to outer ends of the pair of sidewall portions 12 in the tire-radial direction D2. The tread portion 13 is provided with a tread surface 13a which/comes into contact with ground. The tread surface 13a is located on the outer side of in a tire radial-direction D2. The tire 1 is mounted on a rim (not shown).

The tire 1 includes a carcass layer 14 extending between the pair of beads 11a and 11a, and an inner linear 15 located on an inner side of the carcass layer 14 and facing an inner space of the tire 1 into which air is charged. The carcass layer 14 and the inner linear 15 are placed along an inner periphery of the tire over the bead portions 11, the sidewall portions 12 and the tread portion 13.

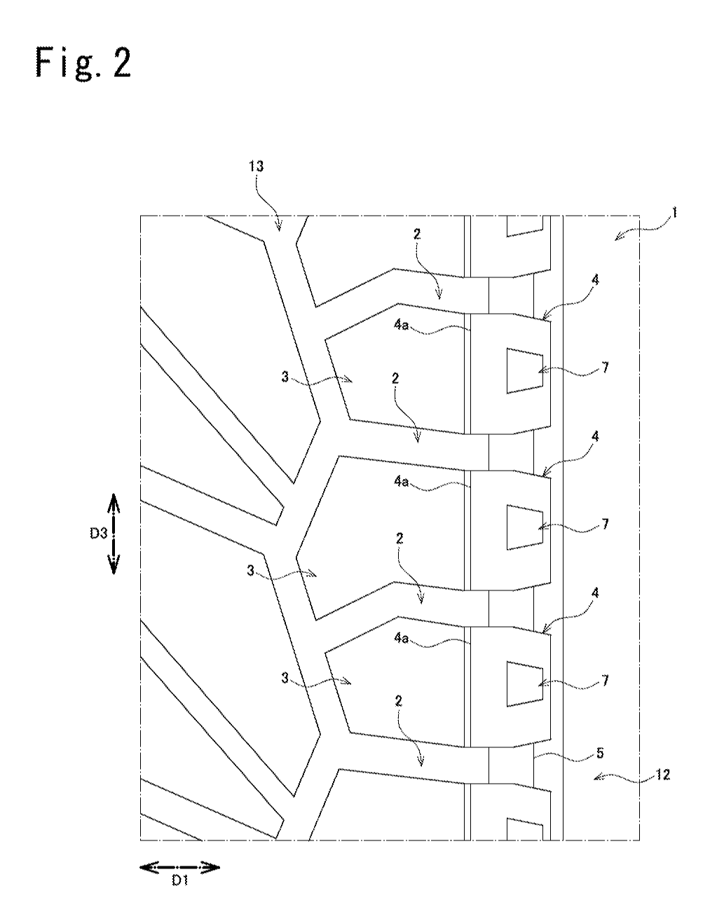

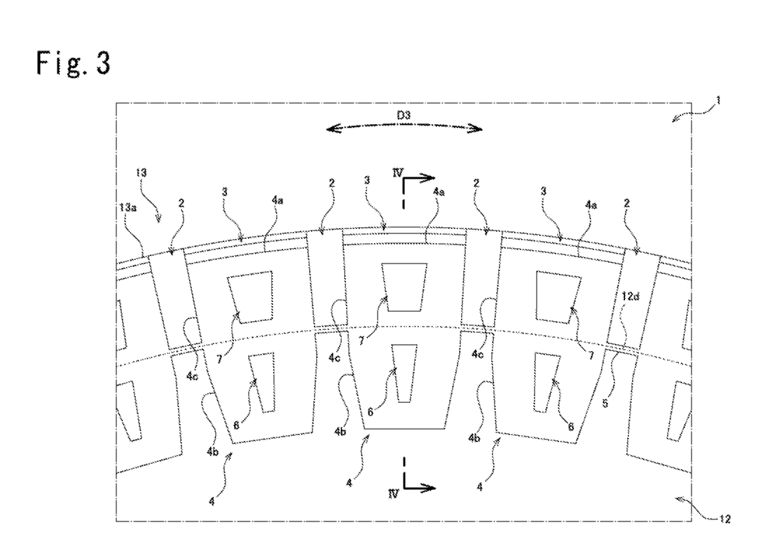

In FIG. 1 (also in the other drawings), a first direction D1 is a tire width-direction D1 which is parallel to the tire rotation axis, a second direction D2 is the tire radial-direction D2 which is a diameter direction of the tire 1, and a third direction D3 (see FIGS. 2 and 3, for example) is a tire circumferential-direction D3 which is a direction around a tire axial-direction. One direction D2a of the second direction D2 is directed inner side of the tire radial-direction D2, and the other direction D2b is directed outer side of the tire radial-direction D2. A tire equator surface S1 is a surface intersecting with the tire rotation axis at right angle, and is located on a center of the tire width-direction D1, and a tire meridional surface is a surface including a surface including the tire rotation axis, and intersecting with the tire equator surface S1.

Each of the beads 11a includes an annularly formed bead core 11b, and a bead filler 11c placed on an outer side of the bead core 11b in the tire radial-direction D2. For example, the bead core lib is formed by laminating rubber-coated bead wires (metal wires, for example), and the bead filler 11c is formed by forming hard rubber outward of the tire radial-direction D2 in a tapered manner.

Each of the bead portions 11 includes a rim strip rubber 11d placed on an outer side in the tire width-direction D1 than the carcass layer 14 to configure an outer surface which comes into contact with the rim. Each of the sidewall portions 12 includes a sidewall rubber 12a which is placed on an outer side in the tire width-direction D1 than the carcass layer 14 to configure an outer surface.

The tread portion 13 includes a tread rubber 13b. An outer surface of the tread rubber 13b configures the tread surface 13a. The tread, portion 13 also includes a belt portion 13c placed between the tread rubber 13b and the carcass layer 14. The belt portion 13c includes a plurality of (four in FIG. 1) belt plies 13d. For example, each of the belt plies 13d includes a plurality of belt cords (organic fiber or metal, for example) which are arranged in parallel, and topping rubbers for coating the belt cords.

The carcass layer 14 is composed of at least one (two in FIG. 1) carcass plies 14a. Each of the carcass plies 14a is folded back around the bead 11a to surround the bead 11a. Each of the carcass plies 14a includes a plurality of ply cords (organic fiber or metal, for example) which are arranged in a direction intersecting with the tire circumferential-direction D3 substantially at right angles, and topping rubbers for coating the ply cords.

To maintain the air pressure, the inner linear 15 has an excellent function to prevent gas from passing through the inner linear 15. In the sidewall portion 12, the inner linear 15 is in intimate contact, with an inner periphery of the carcass layer 14, and no other material is interposed between the inner linear 15 and the carcass layer 14.

For example, in a distance between the carcass ply 14a which is placed on the innermost side and a tire inner peripheral surface (inner peripheral surface of inner linear 15), the distance of the sidewall portion 12 is 90% to 180% of the distance of the tread portion 13. More specifically, the distance of the sidewall portion 12 is 120% to 160% of the distance of the tread portion 13.

An outer surface of the sidewall portion 12 has a position 12b which becomes the same, in the tire radial-direction D2, as the tire maximum position (more specifically, maximum distance position of distance of carcass layer 14 between outer sides in tire width-direction D1). The position 12b is called a tire maximum width position 12b, hereinafter.

The outer surface of the sidewall portions 12 has a position 12c which becomes the same, in the tire radial-direction D2, as an outer end lie of the bead filler 11c in the tire radial-direction D2. The position 12c is called a bead filler outer end position 12c, hereinafter.

The outer surface of the sidewall portions 12 has a position 12d which becomes the same, in the tire radial-direction D2, as an outer end 13e in the tire width-direction D1 in one of the plurality of belt plies 13d which is placed on the innermost side in the tire radial-direction D2. This position 12d is called a belt end position 12d, hereinafter.

As shown in FIGS. 2 to 4, the tread portion 13 includes a plurality of grooves 2 extending to the outer end of the tread portion 13 in the tire width-direction D1, and a plurality of blocks 3 which are defined by the plurality of grooves 2, thereby being arranged in the tire circumferential-direction D3. Each of the sidewall portions 12 includes a plurality of projecting portions 4 projecting from a profile surface (reference surface) S2 in the tire width-direction D1, and an annular protrusion portion 5 projecting from the profile surface S2 in the tire width-direction D1, and extending along the tire circumferential-direction D3.

The projecting portions 4 are placed at least on the outer side in the tire radial-direction D2 of the sidewall portions 12. According to this, the projecting portions 4 can come into contact with mud and sand in a state where the tire 1 sinks due to a weight of the vehicle in a mud area and a sand area, or can come into contact with the uneven rocks in a rocky area. That is, the projecting portions 4 come into contact with the ground in bad roads such as a mud area, a sand area and a rocky area. The projecting portions 4 do not normally come into contact with the ground in a flat road.

The projecting portions 4 are located on an outer side in the tire radial-direction D2 than a bead filler outer end position 12c (see FIG. 1) of the sidewall portion 12. More specifically, the projecting portions 4 are placed on the outer side in the tire radial-direction D2 than a tire maximum width position 12b (see FIG. 1) of the sidewall portion 12.

The projecting portions 4 are placed such that at least portions of them are superposed at least one of the plurality of blocks 3 in the tire radial-direction D2 as viewed from the tire width-direction D1. That is, the projecting portions 4 are superposed on only one of the blocks 3 in the tire radial-direction D2 as viewed from the tire width-direction D1. For example, the projecting portion 4 is superposed on the block 3 in the tire radial-direction D2 as viewed from the tire width-direction D1 by 25% or more in the tire circumferential-direction D3 (preferably 50% or more, more preferably 75% or more).

An outer end 4a of the projecting portion 4 in the tire radial-direction D2 is located on an inner side in the tire radial-direction D2 than the tread surface 13a of the block 3. According to this, an uneven shape is formed by the tread surface 13a of the block 3 and the outer end 4a of the projecting portion 4 in the tire radial-direction D2.

Since the uneven shape exists, components of the surfaces and the edges are formed. The uneven shape is formed on the portion where the tire comes into contact with the ground such as mud, sand and rock, an area which comes into contact with the ground such as mud, sand and rock is increased, or the surface and the edge formed by the uneven shape easily come into contact with the ground such as mud, sand and rock at various positions. If the uneven shape is formed on the portion where the tire comes into contact with the ground such as mud, sand and rock, the traction performance is enhanced.

Each of the projecting portions 4 includes openings 6 and 7. According to this, a weight, of the tire increases due to the existence of the projecting portion 4, and the openings 6 and 7 restrain the weight from increasing. This configuration restrains the weight balance from becoming non-uniform which may be caused by the existence of the projecting portion 4. Due to the existence of the openings 6 and 7, the components of the surfaces and edges are increased and thus, the traction performance is enhanced. The first and second openings 6 and 7 are formed into rectangular shape as viewed from the tire width-direction D1.

The openings 6 and 7 are separated from both end edges of the projecting portion 4 in the tire radial-direction D2. Further, the openings 6 and 7 are separated from the both end. edges of the projecting portion 4 in the tire circumferential-direction D3. According, to this, since, the rigidity of the projecting portion 4 around the openings 6 and 7 can be enhanced, traction performance can be maintained by the projecting portion 4. For example, a width size between the opening edges of the openings 6 and 7 and the end edge of the projecting portion 4 is 1.5 mm or more (preferably, 2.0 mm or more).

The openings 6 and 7 are placed such that they include a center of the projecting portion 4 in the tire circumferential-direction D3. More specifically, central positions of the openings 6 and 7 in the tire circumferential-direction D3 match with the central position of the projecting portion 4 in the tire circumferential-direction D3. The openings 6 and 7 are line-symmetric with respect to center of the projecting portion 4 in the tire circumferential-direction D3. According to this, this configuration restrains the weight balance from becoming non-uniform in the tire circumferential-direction D3, and thus it is possible to restrain the uniformity when the tire is mounted on the vehicle from becoming deteriorated.

Each of the projecting portions 4 is divided into an inner region 4b which is placed on the inner side in the tire radial-direction D2 and an outer region 4c which is placed on the outer side in the tire radial-direction D2. In this embodiment, since the belt end position 12d is located at the same position as the annular protrusion portion 5, the inner region 4b is located on the inner side in the tire radial-direction D2 than the annular protrusion portion 5, and the outer region 4c is located on the outer side in the tire radial-direction D2 than the annular protrusion portion 5.

Each of the projecting portions 4 includes the two openings 6 and 7. More specifically, the projecting portion 4 includes the first opening 6 placed on the inner side in the tire radial-direction D2 and the second opening 7 placed on the outer side in the tire radial-direction D2. The first opening 6 is placed on the inner side in the tire radial-direction D2 than the annular protrusion portion 5, and the second opening 7 is placed on the outer side in the tire radial-direction D2 than the annular protrusion portion 5. That is, the first opening 6 is placed in the inner region 4b, and the second opening 7 is placed in the outer region 4c.

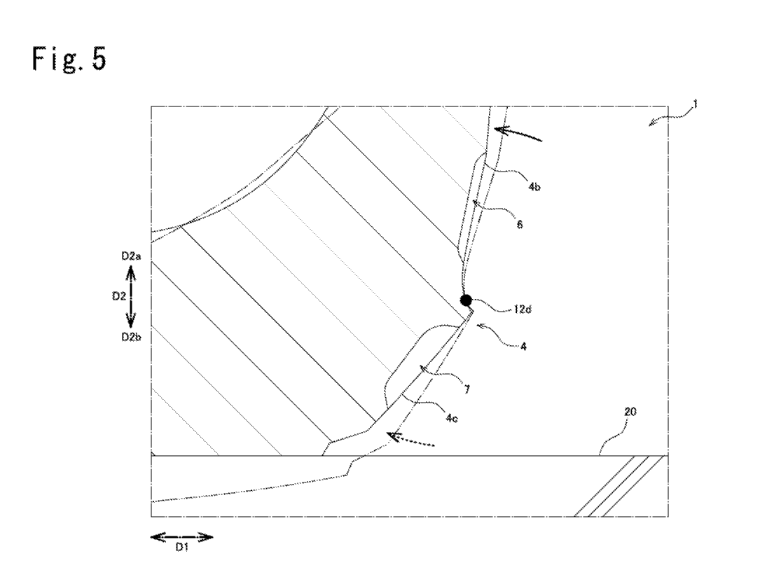

As shown in FIG. 5, when the tire 1 mounted on the vehicle comes into contact with the ground 20, the tire 1 becomes deformed by the weight of the vehicle and the like. In FIG. 5, dashed-two dotted lines show shapes before the tire is deformed, and solid lines show shapes after deformation. At this time, the tire 1 generally becomes deformed differently from the. belt end position 12d as a reference.

More specifically, the inner region 4b becomes deformed such that it is oriented to the sideway as shown by the solid lines, and the outer region 4c becomes deformed such that it is oriented to the ground 20 as shown by a broken arrow. Therefore, the second opening 7 in the outer region 4c acts advantageously for the traction when the tire 1 comes into contact with the ground such as mud accumulated on the surface of the ground 20.

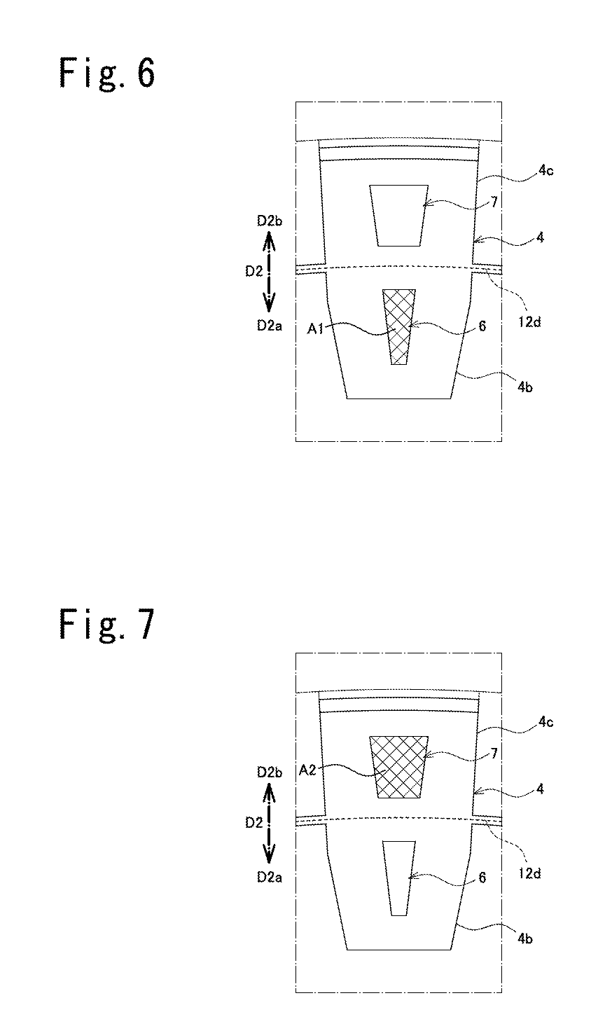

In the projecting portion 4 having the openings 6 and 7, as shown in FIGS. 6 and 7, a total sum A2 of the opening area (meshed region in FIG. 7) of the second opening 7 in the outer region 4c is greater than a total sum A1 of the opening area (meshed region in FIG. 6) of the first opening 6 in the inner region 4b. According to this, since mud becomes prone to enter the second opening 7, mud in the second opening 7 is easily sheared. Therefore, it is possible to enhance the traction performance in the mud area.

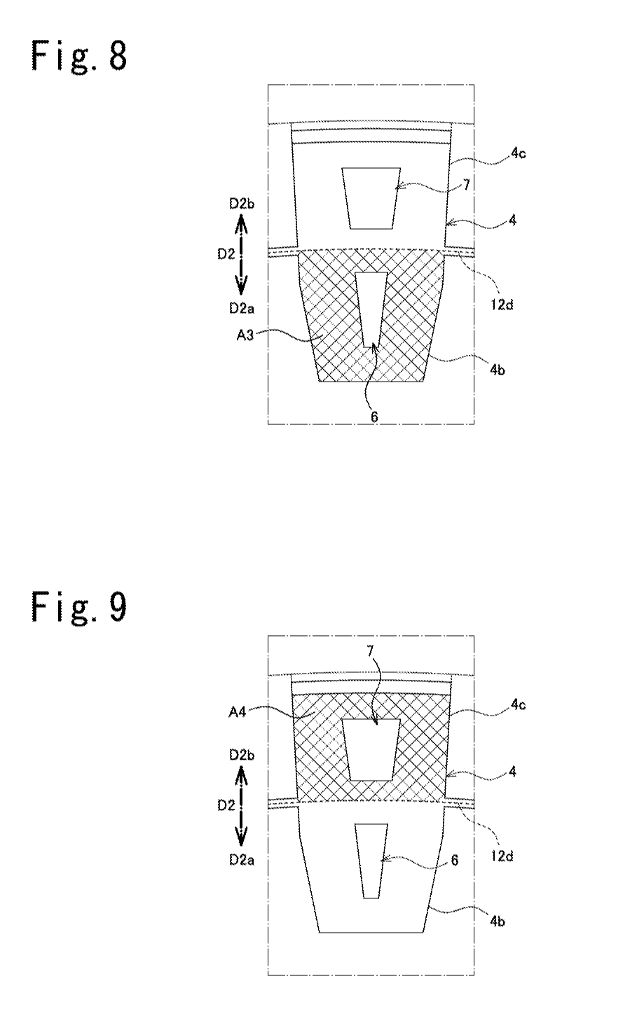

As shown in FIGS. 6 to 9, a ratio (A2/A4) of the total sum A2 of the opening area of the second opening 7 to an actual area A4 (meshed region in FIG. 9) of the projecting portion 4 in the outer region 4c is greater than a ratio (A1/A3) of the total sum A1 of an. opening .area of the first opening 6 to. aa actual area A3 (meshed region in FIG. 8) of the projecting portion 4 in the inner region 4b. According to this, since mud easily enters the second opening 7, mud in the second opening 7 is easily sheared. Therefore, it is possible to enhance the traction performance in the mud area.

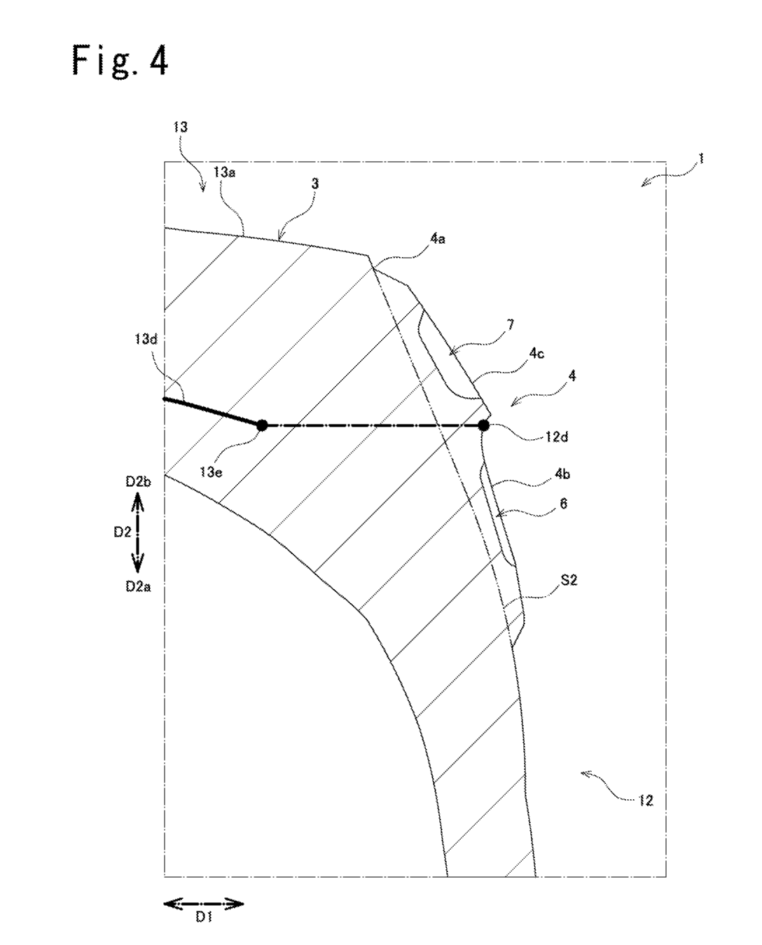

Referring back to FIG. 4, a depth (maximum depth) of the second opening 7 in the outer region 4c is greater than a depth (maximum depth) of the first opening 6 in the inner region 4b. According to this, since a surface of the second opening 7 becomes large, resistance when the second opening 7 shears mud becomes great. Therefore, it is possible to enhance the traction performance in the mud area.

Further, a projecting amount (maximum projecting amount) of the projecting portion 4 in the outer region 4c becomes greater than a projecting amount (maximum projecting amount) of the projecting portion 4 in the inner region 4b. According to this, although the opening area of the second opening 7 is great and the depth of the second opening 7 is deep, a rubber volume of the outer region 4c is secured. Therefore, it is possible to restrain the resistance to external damage of the outer region 4c from being deteriorated.

As described above, the pneumatic tire 1 of the embodiment include a sidewall portion 12 extending in a tire radial-direction D2, and a tread portion 13 having a tread surface 13a on an outer side in the tire radial-direction D2 and connected to an outer end of the sidewall portion 12 in the tire radial-direction D2. The tread portion 13 includes a tread rubber 13b placed on the outer side in the tire radial-direction D2, and at least one belt ply 13d placed on an inner side of the tread rubber 13b in the tire radial-direction D2. The tread rubber 13b includes a plurality of grooves 2 extending to an outer end in a tire width-direction D1, and a plurality of blocks 3 arranged in a tire circumferential-direction D3 by being defined by the plurality of grooves 2. The sidewall portion 12 includes a plurality of projecting portions 4 projecting in the tire width-direction D1. The projecting portions 4 are placed such that at least portions of the projecting portions 4 are superposed on one of the plurality of blocks 3 in the tire radial-direction D2 as viewed from the tire width-direction D1. At least one of the plurality of projecting portions 4 includes at least one openings 6 and 7. At least one of the projecting portions 4 is divided into an inner region 4b placed on the inner side in the tire radial-direction D2 and an outer region 4c placed on the outer side in the tire radial-direction D2 with respect to a position of an outer end 13e of the belt play 13d in the tire width-direction Dl, wherein the belt play 13d placed on the innermost side in the tire radial-direction D2. The total sum A2 of the opening area of the opening 7 in the outer region 4c is greater than the total sum A1 of the opening area of the opening 6 in the inner region 4b.

According to the above-described configuration, the projecting portion 4 is placed such that at least portion of the projecting portion 4 is superposed on at least one of the plurality of blocks 3 in the tire radial-direction D2 as viewed from the tire width-direction D1. Therefore, traction performance is exhibited by a positional relation (e.g., uneven shape) between the block 3 and the projecting portion 4 in the tire width-direction D1.

Due to the existence of the projecting portions 4, a rubber weight of this portion is increased. Hence, at least one of the plurality of projecting portions 4 includes the openings 6 and 7. According to this, it is possible to restrain the unevenness of the weight balance which may be caused by the existence of the projecting portions 4. Further, the traction performance is exhibited by the surfaces and the edges of the openings 6 and 7.

In the sidewall portions 12, generally, the outer region 4c located on the outer side in the tire radial-direction D2 becomes deformed such that the outer region 4c is oriented to the ground 20 from the position, as a reference, of the outer end 13e of the tire width-direction D1 of the belt ply 13d placed on the innermost side in the tire radial-direction D2. Hence, the total sum A2 of the opening area of the opening 7 in the outer region 4c is greater than the total sum A1 of the opening area of the opening 6 in the inner region 4b.

According to this, since mud easily enters the opening 7 in the outer region 4c, it becomes easy to shear the mud in the opening 7 in the outer region 4c. Therefore, it is possible to efficiently enhance the traction performance particularly in the mud area.

In the pneumatic tire 1 of the embodiment, in a ratio of the total sums A1 and A2 of the opening areas of the openings 6 and 7 with respect to an actual areas A3 and A4 of the projecting portion 4, the ratio (A2/A4) of the outer region 4c is greater than the ratio (A1/A3) of the inner region 4b.

According to the above-described configuration, in the ratio of the total sums A1 and A2 of the opening areas of the openings o and 7 to the actual areas A3 and A4 of the projecting portion 4, the ratio (A2/A4) of the outer region 4c is greater than the ratio (A1/A3) of the inner region 4b, Therefore, mud easily .enters the opening 7 of the outer region 4c. According to this, since shear of mud in the opening 7 in the outer region 4c is more easily generated, it is possible to further efficiently enhance the traction performance in the mud area.

In the pneumatic tire 1 of the embodiment, a depth of the opening 7 in the outer region 4c is greater than a depth of the opening 6 in the inner region 4b.

According to the above-described configuration, the depth of the opening 7 in the outer region 4c is greater than the depth of the opening 6 in the inner region 4b. Hence, a surface of the opening 7 in the outer region 4c becomes large. According to this, since resistance when the opening 7 in the outer region 4c shears mud becomes large, it is possible to further efficiently enhance the traction performance in the mud area.

In the pneumatic tire 1 of the embodiment, a projecting amount of the projecting portion 4 in the outer region 4c is greater than a projecting amount, of the projecting portion 4 in the inner region 4b.

According to the above-described Configuration,, since the projecting amount of the projecting portion 4 in the outer region 4c becomes greater than the projecting amount of the projecting portion 4 in the inner region 4b, it is possible to restrain the rubber volume of the outer region 4c from becoming small. According to this, it is possible to restrain the resistance to external damage of the outer region 4c from being deteriorated.

The pneumatic tire is not limited to the configuration of the first embodiment, and the pneumatic tire is not limited to the effect of the first embodiment. For example, the pneumatic tire of the first embodiment may be changed in the following manners.

In the pneumatic tire 1 of the first embodiment, in the ratio of the total sums A1 and A2 of the openings 6 and 7 to the actual areas A3 and A4 of the projecting portion 4, the ratio (A2/A4) of the outer region 4c is greater than the ratio: (A1/A3) of the inner region 4b. However, the pneumatic tire is not limited to this configuration. For example, the ratio (A2/A4) of the outer region 4c may be smaller than the ratio (A1/A3) of the inner region 4b. Alternatively, the ratio (A2/A4) of the outer region 4c may be the same as the ratio (A1/A3) of the inner region 4b.

In the pneumatic tire 1 of the first embodiment, the depth of the opening 7 in the outer region 4c is greater than the depth of the opening 6 in the inner region 4b. However, the pneumatic tire is not limited to this configuration. For example, the depth of the opening 7 in the outer region 4c may be smaller than the depth of the opening 6 in the inner region 4b. Alternatively, the depth of the opening 7 in the outer region 4c may be the same as the depth of the opening 6 in the inner region 4b.

In the pneumatic tire 1 of the first embodiment, the projecting amount of the projecting portion 4 in the outer region 4c is greater than the projecting amount of the projecting portion 4 in the inner region 4b. However, the pneumatic tire is not limited to this configuration. For example, the projecting amount of the projecting portion 4 in the outer region 4c may be smaller than the projecting amount of the projecting portion 4 in the inner region 4b. Alternatively, the projecting amount of the projecting portion 4 in the outer region 4c may be the same as the projecting amount of the projecting portion 4 in the inner region 4b.

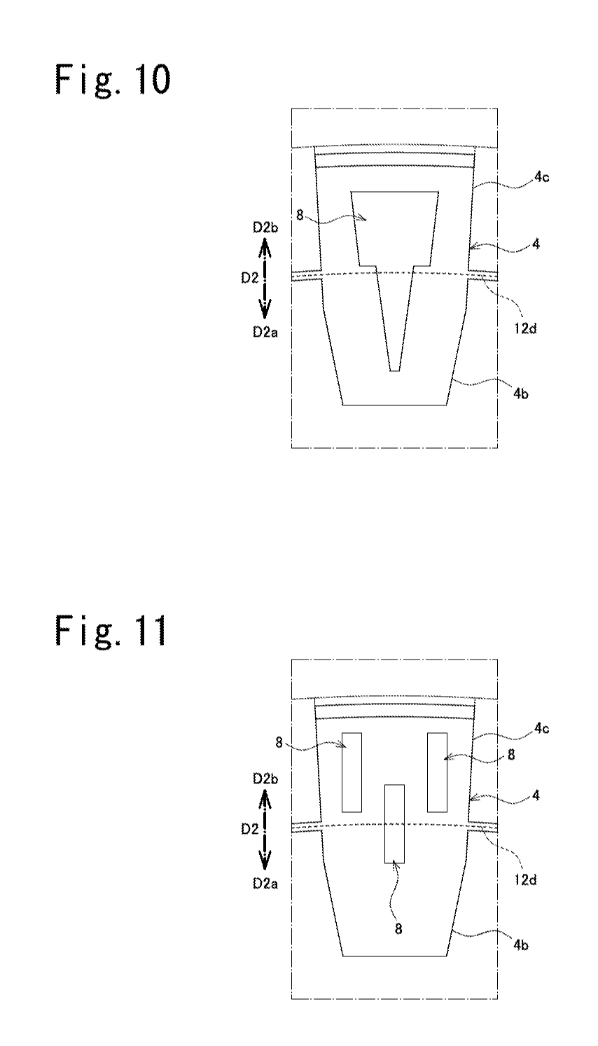

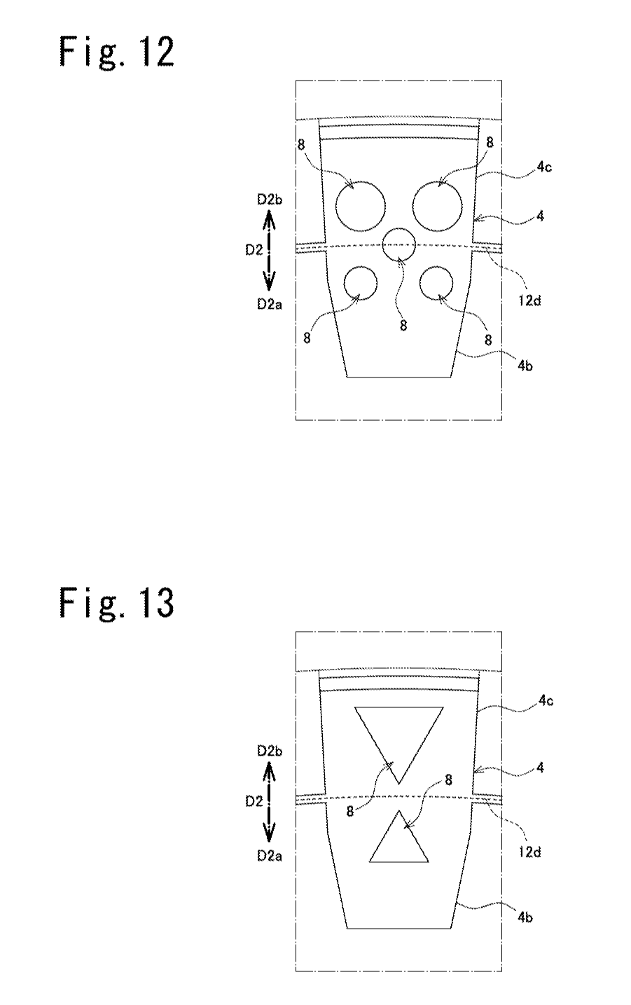

As shown in FIG. 10 for example, one opening 8 may be provided in one projecting portion 4. Further, as shown in FIG. 11 for example, three openings 8 may be provided in one projecting portion 4. Alternatively, as shown in FIG. 12, five openings 8 may be provided in one projecting portion 4.

In the pneumatic tire 1 of the first embodiment, the openings 6 and 7 are formed into the rectangular shapes as viewed from the tire width-direction D1. However, the pneumatic tire is not limited to this configuration. As shown in FIG. 10 for example, the opening 8 may be formed into a polygonal shape having five angle portions or more as viewed from the tire width-direction D1. Further, as shown in FIG. 12 for example, the opening 8 may be formed into a circular (perfect circular, elliptic) shape as viewed from the tire width-direction D1. Further, as shown in FIG. 13 for example, the opening 8 may be formed into a triangular shape as viewed from the tire width-direction D1.

<Second Embodiment>

Next, a second embodiment in the pneumatic tire will be described with reference to FIGS. 14 to 25. In FIGS. 14 to 25, elements to which the same reference signs as those of FIGS. 1 to 13 are denoted have substantially the same configurations or functions (effects) as the first embodiment, and description thereof will not be repeated.

As shown in FIGS. 14 to 16, a tread portion 13 includes a plurality of grooves 2 and a plurality of blocks 3, each of sidewall portions 12 includes a plurality of projecting portions 4 and an annular protrusion portion 5, and each of the projecting portions 4 includes openings 6 and 7. Configuration of the projecting portions 4 and the openings 6 and 7 of this embodiment are different from those of the projecting portions 4 and the openings 6 and 7 of the first embodiment.

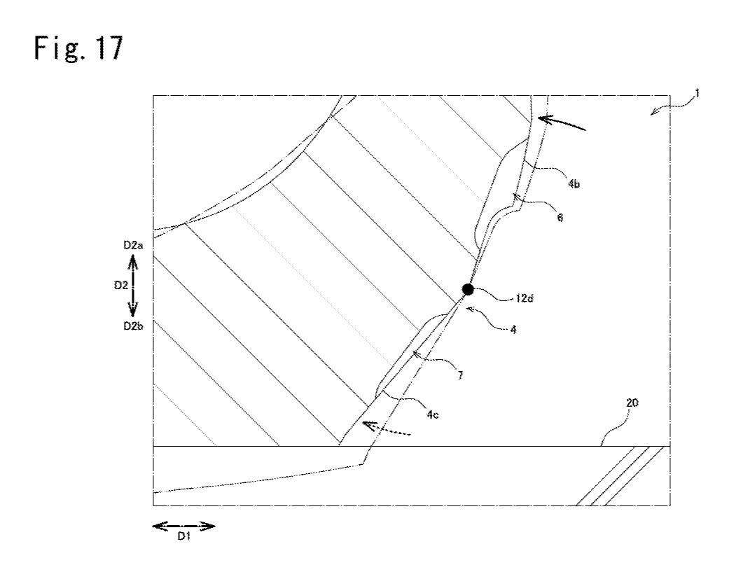

As shown in FIG. 17, when a tire 1 mounted on a vehicle comes into contact with ground 20, the tire 1 becomes deformed by weight, of the vehicle and the like. In FIG. 17, dashed-two dotted lines show shapes before the tire is deformed, and solid lines show shapes after deformation. At this time, the tire 1 generally becomes deformed differently from the belt, end position 12d as a reference.

More specifically, the inner region 4b becomes deformed such that it is oriented to the sideway as shown by the solid lines, and the outer region 4c becomes deformed such that it is oriented to the ground 20 as shown by a broken arrow. Therefore, the first opening 6 of the inner region 4b acts advantageously for the traction when the tire 1 comes into contact with the ground such as rock standing from the surface of the ground 20.

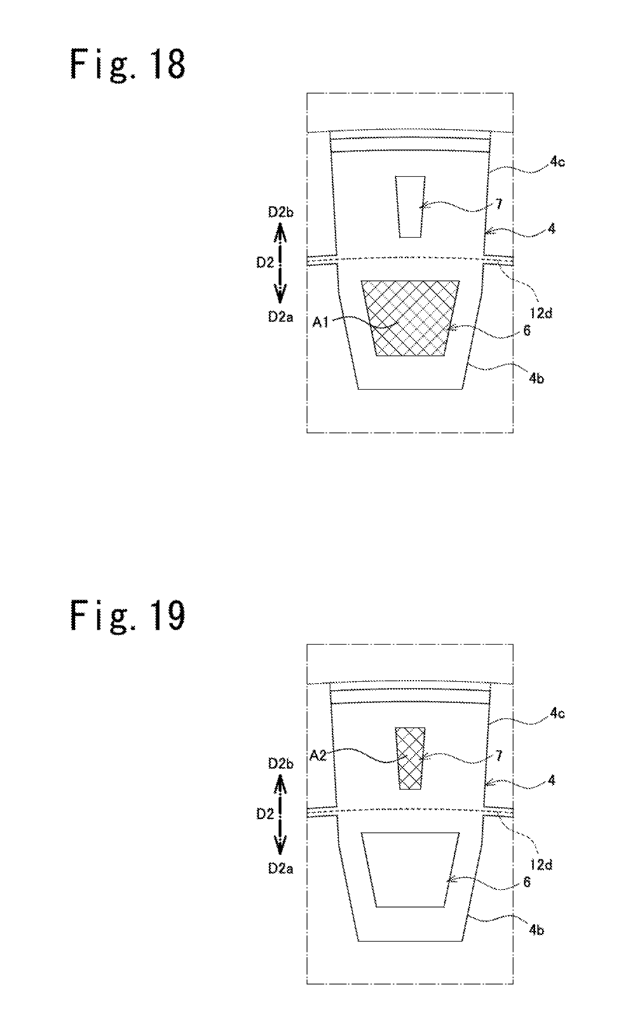

In the projecting portion 4 having the openings 6 and 7, as show in FIGS. 18 and 19, a total, sum A1 of an opening area (meshed region in FIG. 18) of the first opening 6 in the inner region 4b is greater than a total sum A2 of an opening area (meshed region in FIG. 19) of the second opening 7 in the outer region 4c. According to this, since rock easily come into contact with a surface and an edge of the first opening 6, friction is easily generated between the first opening 6 and the rock. Therefore, it is possible to enhance the traction performance in the rocky area.

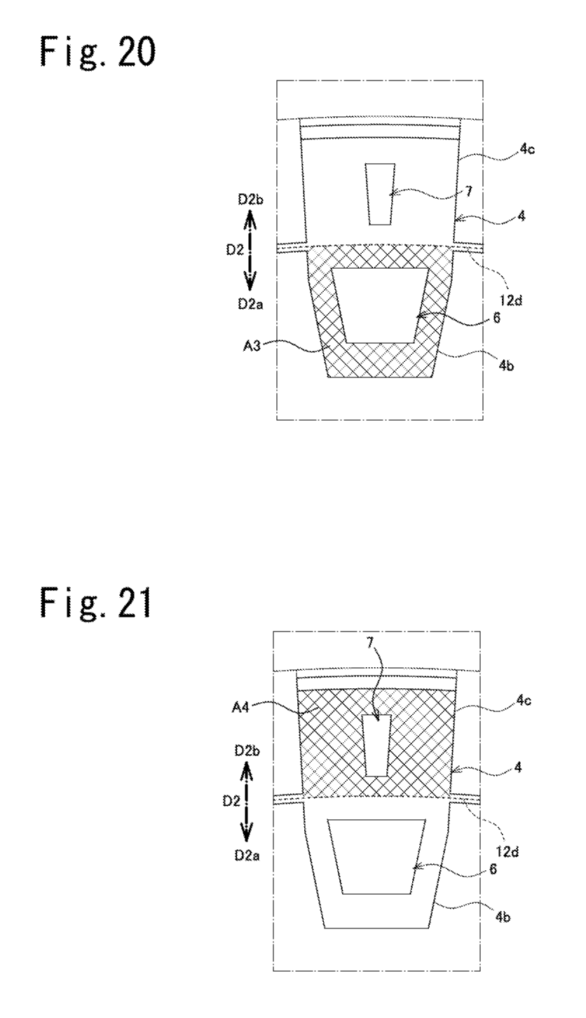

As shown in FIGS. 18 to 21, a ratio (A1/A3) of a total sum AI of an opening area of the first opening 6 to an actual area A3 (meshed area in FIG. 20) of the projecting portion 4 in the inner region 4b is greater than a ratio (A2/A4) of a total sum A2 of an opening area of the second opening 7 to an actual area A4 (meshed area in FIG. 21) of the projecting portion 4 in the outer region 4c. According to this, since a rock easily comes into contact with a surface and an edge of the first opening 6, friction is more easily generated between the first opening 6 and the rock. Therefore, it is possible to enhance the traction performance in the rocky area.

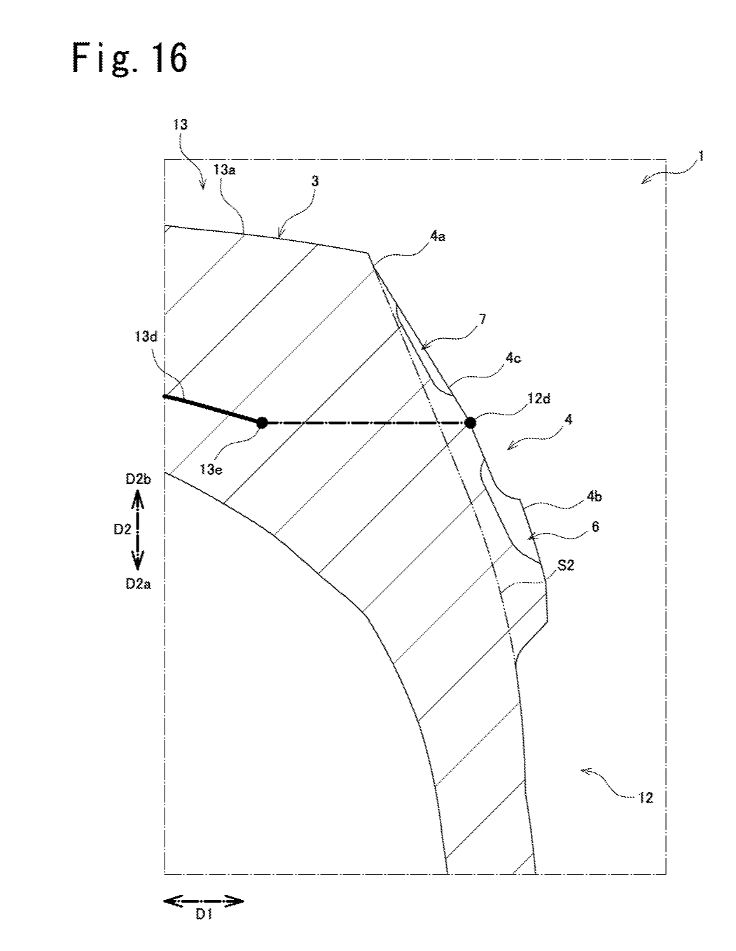

Referring back to FIG. 16, a depth (maximum depth) of the first opening 6 in the inner region 4b is greater than a depth (maximum depth) of the second opening 7 in the outer region 4c. According to this, since a surface of the first opening 6 becomes large, friction .between the first opening 6 and a rock becomes great. Therefore, it is possible to enhance the traction performance in the rocky area.

Further, a projecting amount (maximum projecting amount) of the projecting portion 4 in the inner region 4b becomes greater than a projecting amount (maximum projecting amount) of the projecting portion 4 in the outer region 4c. According to this, although the opening area of the first opening 6 is great and the depth of the first opening 6 is deep, a rubber volume of the inner region 4b is secured. Therefore, it is possible to restrain the resistance to external damage of the inner region 4b from being deteriorated.

As described above, the pneumatic tire 1 of the embodiment include a sidewall portion 12 extending in a tire radial-direction D2, and a tread portion 13 having a tread surface 13a on an outer side in the tire radial-direction D2 and connected to an outer end of the sidewall portion 12 in the tire radial-direction D2. The tread portion 13 includes a tread rubber 13b placed on the outer side in the tire radial-direction D2, and at least one belt ply 13d placed on an inner side of the tread rubber 13b in the tire radial-direction D2. The tread rubber 13b includes a plurality of grooves 2 extending to an outer end in a tire width-direction D1, and a plurality of blocks 3 arranged in a tire circumferential-direction D3 by being defined by the plurality of grooves 2. The sidewall portion 12 includes a plurality of projecting portions 4 projecting in the tire width-direction D1. The projecting portions 4 are placed such that at least portions of the projecting portions 4 are superposed on one of the plurality of blocks 3 in the tire radial-direction D2 as viewed from the tire width-direction D1. At least one of the plurality of projecting portions 4 includes at least one openings 6 and 7. At least one of the projecting portions 4 is divided into an inner region 4b placed on the inner side in the tire radial-direction D2 and an outer region 4c placed on the outer side in the tire radial-direction D2 with respect to a position of an outer end 13e of the belt play 13d in the tire width-direction D1, wherein the belt play 13d placed on the innermost side in the tire radial-direction D2. The total sum A2 of the opening area of the opening 7 in the outer region 4c is greater than the total sum A1 of the opening area of the opening 6 in the inner region 4b. The total sum A1 of the opening area of the opening 6 in the inner region 4b is greater than the total sum A2 of the opening area of the opening 7 in the outer region 4c.

According to the above-described configuration, the projecting portion 4 is placed such that at least portion of the projecting portion 4 is superposed on at least one of the plurality of blocks 3 in the tire radial-direction D2 as viewed from the tire width-direction D1. Therefore, traction performance is exhibited by a positional relation (e.g., uneven shape) between the block 3 and the projecting portion 4 in the tire width-direction D1.

Due to the existence of the projecting portions 4, a rubber weight of this portion is increased. Hence, at least one of the plurality of projecting portions 4 includes the openings 6 and 7. According to this, it is possible to restrain the unevenness of the weight balance which may be caused by the existence of the projecting portions 4. Further, the traction performance is exhibited by the surfaces and the edges of the openings 6 and 7.

In the sidewall portions 12, generally, the inner region 4b located on the inner side in the tire radial-direction D2 becomes deformed such that the inner region 4b is oriented to sideway from the position, as a reference, of the outer end 13e of the tire width-direction D1 of the belt ply 13d placed on the innermost side in the tire radial-direction D2. Hence, the total sum A1 of the opening area of the opening 6 in the inner region 4b is greater than the total sum A2 of the opening area of the opening 7 in the outer region 4c.

According to this, since rock easily comes into contact with the surface and the edge of the opening 6, friction is easily generated between the opening 6 of the inner region 4b and the rock. Therefore, for example, it is possible to efficiently enhance the traction performance particularly in the rocky area.

In the pneumatic tire 1 of the embodiment, in a ratio of the total sums A1 and A2 of the opening areas of the openings 6 and 7 with respect to an actual areas A3 and A4 of the projecting portion 4, the ratio (A1/A3) of the inner region 4b is greater than the ratio (A2/A4) of the outer region 4c.

According to the above-described configuration, in the ratio of the total sums A1 and A2 of the opening areas of the openings 6 and 7 to the actual areas A3 and A4 of the projecting portion 4, the ratio (A1/A3) of the inner region 4b is greater than the ratio (A2/A4) of the outer region 4c. Therefore, rock easily comes into contact with the surface and the edge of the opening 6 in the inner region 4b. According to this, friction is more easily generated between the opening 6 of the inner region 4b and the rock. Hence, it is possible to further efficiently enhance the traction performance in the rocky area.

In the pneumatic tire 1 of the embodiment, a depth of the opening 6 in the inner region 4b is greater than a depth of the opening 7 in the outer region 4c.

According to the above-described configuration, since the depth of the opening 6 in the inner region 4b is greater than the depth of the opening 7 in the outer region 4c, the surface of the opening 6 in the inner region 4b becomes large. According to this, since a friction force between the opening 6 in the inner region 4b and rock becomes large, for example, it is possible to further efficiently enhance the traction performance in the rocky area.

In the pneumatic tire 1 of the embodiment, a projecting amount of the projecting portion 4 in the inner region 4b is greater than a projecting amount of the projecting portion 4 in the outer region 4c.

According to the above-described configuration, the projecting amount of the projecting portion 4 in the inner region 4b becomes greater than a projecting amount of the projecting portion 4 in the outer region 4c. Therefore, it is possible to restrain the rubber volume of the inner region 4b from becoming small, for example. According to this, it is possible to restrain the resistance to external damage of the inner region 4b from being deteriorated, for example.

The pneumatic tire is not limited to the configuration of the second embodiment, and the pneumatic tire is not limited to the effect of the second embodiment. For example, the pneumatic tire of the second embodiment may be changed in the following manners.

In the pneumatic tire 1 of the second embodiment, in the ratio of the total sums A1 and A2 of the opening areas of the openings 6 and 7 to the actual areas A3 and A4 of the projecting portion 4, the ratio (A1/A3) of the inner region 4b is greater than the ratio (A2/A4) of the outer region 4c. However, the pneumatic tire is not limited to this configuration. For example, the ratio (A1/A3) of the inner region 4b may be smaller than the ratio (A2/A4) of the outer region 4c. Alternatively, the ratio (A1/A3) of the inner region 4b may be the same as the ratio (A2/A4) of the outer region 4c.

In the pneumatic tire 1 of the second embodiment, the depth of the opening 6 in the inner region 4b is greater than the depth of the opening 7 in the outer region 4c. However, the pneumatic tire is not limited to this configuration. For example, the depth of the opening 6 in the inner region 4b may be smaller than the depth of the opening 7 in the outer region 4c. Alternatively, the depth of the opening 6 in the inner region 4b pay toe the same as the depth of the opening 7 in the outer region 4c.

In the. pneumatic tire 1 of the second embodiment, the projecting amount of the projecting portion 4 in the inner region 4b is greater than the projecting amount of the projecting portion 4 in the outer region 4c. However, the pneumatic tire is not limited to this configuration. For example, the projecting amount of the projecting portion 4 in the inner region 4b may be smaller than the projecting amount of the projecting portion 4 in the outer region 4c. Alternatively, the projecting amount of the projecting portion 4 in the inner region 4b may be the same as the projecting amount of the projecting portion 4 in the outer region 4c.

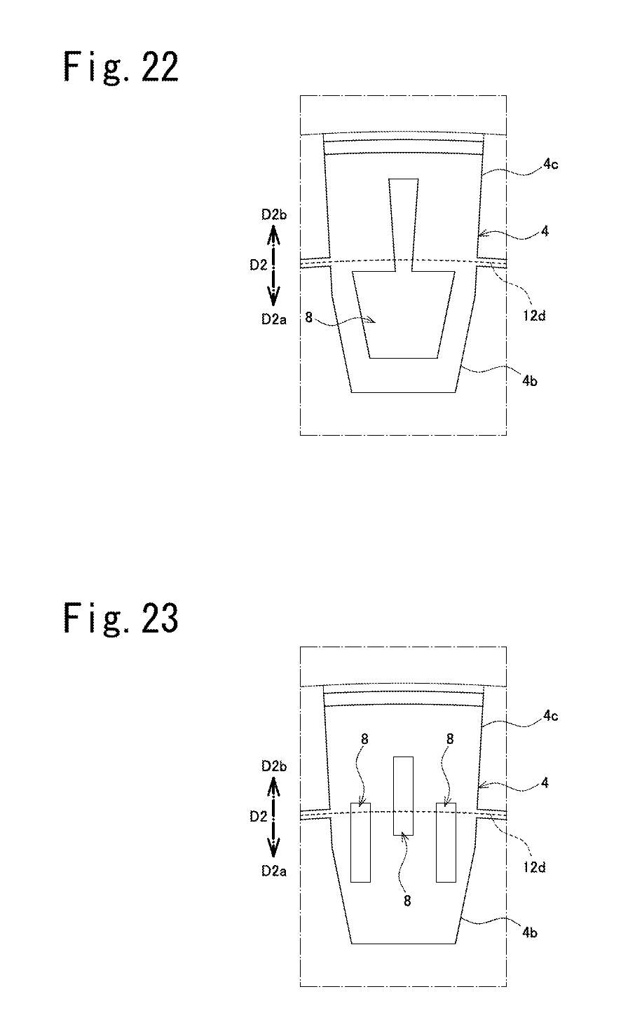

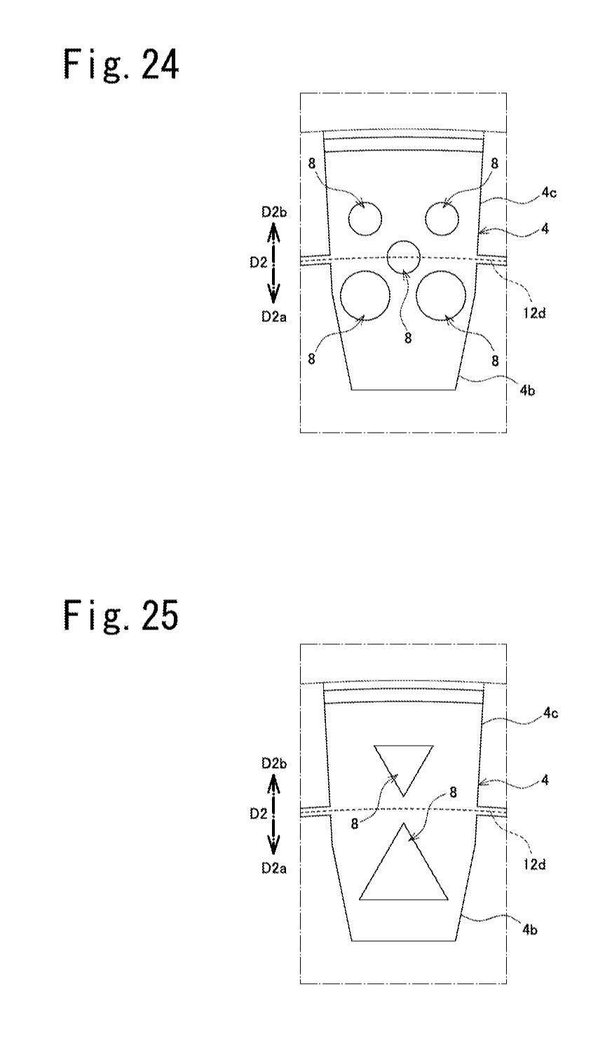

Further, as shown in FIG. 22 for example, one opening 8 may be provided in one projecting portion 4. Further, as shown in FIG. 23 for example, three openings 8 may be provided in one projecting portion 4. Further, as shown in FIG. 24 for example, five openings 8 may be provided in one projecting portion 4.

In the pneumatic tire 1 of the second embodiment, the openings 6 and 7 are formed into the rectangular shapes as viewed from the tire width-direction D1. However, the pneumatic tire is not limited to this configuration. As shown in FIG. 22 for example, the opening 8 may be formed into a polygonal shape having five angle portions or more as viewed from the tire width-direction D1. Further, as shown in FIG. 22 for example, the opening 8 may be formed into a circular (perfect circular, elliptic) shape as viewed from the tire width-direction D1. Further, as shown in FIG. 25 for example, the opening 8 may be formed into a triangular shape as viewed from the tire width-direction D1.

Note that, the pneumatic tire is not limited to the configurations of the above-described embodiment, and is not limited to the above-described working effects. The pneumatic tire can of course be variously modified within a scope not departing from the subject matters of the present invention. For example, the configurations and methods of the above-described plurality of embodiments may arbitrarily be employed and combined (configuration or method of one of embodiments may be applied to configuration or method of other embodiment), and it is possible to arbitrarily select one or more of configurations and methods of the later-described various modifications, and such configurations and methods may be employed for the configurations or the methods of the above-described embodiments.

In the pneumatic tire 1 of the embodiments, two openings 6 and 7 are provided in one projecting portion 4. However, the pneumatic tire is not limited to this configuration. For example, one or three or more openings may be provided in one projecting portion 4.

In the pneumatic tire 1 of the embodiments, the openings 6 and 7 are provided in all of the projecting portions 4. However, the pneumatic tire is not limited to this configuration. For example, it is only necessary that the openings 6 and 7 are provided at least in one of the plurality of projecting portions 4. It is preferable that the openings 6 and 7 are provided at least in ¼ of the plurality of projecting portions 4, it is more preferable that the openings 6 and 7 are provided at least in ⅓, and it is more preferable that the openings 6 and 7 are provided at least in ½.

In the pneumatic tire 1 of the embodiments, all of the projecting portions 4 have the same shapes, and all of the openings 6 and 7 have the same shape. However, the pneumatic tire is not limited to this configuration. The projecting portions 4 may have different shapes, and they may be placed in series in the tire circumferential-direction D3. Further, the openings 6 and 7 may have a plurality of different shapes, and may be placed in the respective projecting portions 4 in series in the tire circumferential-direction D3.

In the pneumatic tire 1 of the embodiments, the openings 6 and 7 are respectively separated from both end edges of the projecting portion 4 in the. tire radial-direction D2. However, the pneumatic tire is not limited to this configuration. The openings 6 and 7 may be separated only from one of the end edges of the projecting portion 4 in the tire radial-direction D2.

In the pneumatic tire 1 of the embodiments, the openings 6 and 7 are respectively separated from both end edges of the projecting portion 4 in the tire circumferential-direction D3. However, the pneumatic tire is not limited to this configuration. The openings 6 and 7 may be separated only from one of the end edges of the projecting portion 4 in the tire circumferential-direction D3.

In the pneumatic tire 1 of the embodiments, the projecting portions 4 are provided on both of the pair of sidewall portions 12. However, the pneumatic tire is not limited to this configuration. For example, the projecting portions 4 may be provided on one of the pair of sidewall portions 12. For example, the projecting portions 4 may be provided on at least one of the pair of sidewall portions 12 which is placed on the outer side when the tire is mounted on the vehicle.

The pneumatic tire 1 may employ such as configuration that the projecting portions 4 are provided on both of the pair of sidewall portions 12 but the openings 6 and 7 are provided on one of or both of the sidewall portions 12. For example, the openings 6 and 7 may be provided on one of the pair of sidewall portions 12 which is placed on the outer side when the tire is mounted on the vehicle.

What is claimed is:

1. A pneumatic tire comprising:
a sidewall portion extending in a tire radial-direction; and
a tread portion having a tread surface on an outer side in the tire radial-direction and connected to an outer end of the sidewall portion in the tire radial-direction, wherein
the tread portion includes a tread rubber placed on the outer side in the tire radial-direction, and at least one belt ply placed on an inner side of the tread rubber in the tire radial-direction,
the tread rubber includes a plurality of grooves extending to an outer end in a tire width-direction, and a plurality of blocks arranged in a tire circumferential-direction by being defined by the plurality of grooves,
the sidewall portion includes a plurality of projecting portions projecting in the tire width-direction,
the projecting portions are placed such that at least portions of the projecting portions are superposed on one of the plurality of blocks in the tire radial-direction as viewed from the tire width-direction,
at least one of the plurality of projecting portions includes at least one opening,
at least one of the projecting portions is divided into an inner region placed on the inner side in the tire radial-direction and an outer region placed on the outer side in the tire radial-direction with respect to a position of an outer end of the belt play in the tire width-direction, wherein the belt play placed on the innermost side in the tire radial-direction, and
a total sum of an opening area of the opening in the outer region is different, from a total sum of an opening area of the opening in the inner region.

2. The pneumatic tire according to claim 1, wherein the total sum of the opening area of the opening in the outer region is greater than the total sum of the opening area of the opening in the inner region.

3. The pneumatic tire according to claim 2, wherein in a ratio of the total sums of the opening areas of the opening with respect to an actual area of the projecting portion, the ratio of the outer region is greater than the ratio of the inner region.

4. The pneumatic tire according to claim 2, wherein a depth of the opening in the outer region is greater than a depth of the opening in the inner region.

5. The pneumatic tire according to claim 2, wherein a projecting amount of the projecting portion in the outer region is greater than a projecting amount of the projecting portion in the inner region.

6. The pneumatic tire according to claim 1, wherein the total sum of the opening area of the opening in the inner region is greater than the total sum of the opening area of the opening in the outer region.

7. The pneumatic tire according to claim 6, wherein in a ratio of the total sums of the opening areas of the opening with respect to an actual area of the projecting portion, the ratio of the inner region is greater than the ratio of the outer region.

8. The pneumatic tire according to claim 6, wherein a depth of the opening in the inner region is greater than a depth of the opening in the outer region.

9. The pneumatic tire according to claim 6, wherein a projecting amount of the projecting portion in the inner region is greater than a projecting amount of the projecting portion in the outer region.

10. A pneumatic tire comprising:
a sidewall portion extending in a tire radial-direction; and
a tread portion having a tread surface on an outer side in the tire radial-direction and connected to an outer end of the sidewall portion in the tire radial-direction, wherein
the tread portion includes a tread rubber placed on the outer side in the tire radial-direction, and at least one belt ply placed on an inner side of the tread rubber in the tire radial-direction,
the tread rubber includes a plurality of grooves extending to an outer end in a tire width-direction, and a plurality of blocks arranged in a tire circumferential-direction by being defined by the plurality of grooves,
the sidewall portion includes a plurality of projecting portions projecting in the tire width-direction,
the projecting portions are placed such that at least portions of the projecting portions are superposed on one of the plurality of blocks in the tire radial-direction as viewed from the tire width-direction,
at least one of the plurality of projecting portions includes at least one opening,
at least one of the projecting portions is divided into an inner region placed on the inner side in the tire radial-direction and an outer region placed on the outer side in the tire radial-direction with respect to a position of an outer ends of the belt play in the tire width-direction, wherein the belt play placed on the innermost side in the tire radial-direction, and
the total sum of the opening area of the opening in the outer region is equal to or greater than the total sum of the opening area of the opening in the inner region.

11. A pneumatic tire comprising:
a sidewall portion extending in a tire radial-direction; and
a tread portion having a tread surface on an outer side in the tire radial-direction and connected to an outer end of the sidewall portion in the tire radial-direction, wherein
the tread portion includes a tread rubber placed on the outer side in the tire radial-direction, and at least one belt ply placed on an inner side of the tread rubber in the tire radial-direction,
the tread rubber includes a plurality of grooves extending to an outer end in a tire width-direction, and a plurality of blocks arranged in a tire circumferential-direction by being defined by the plurality of grooves,
the sidewall portion includes a plurality of projecting portions projecting in the tire width-direction,
the projecting portions are placed such that at least portions of the projecting portions are superposed on one of the plurality of blocks in the tire radial-direction as viewed from the tire width-direction,
at least one of the plurality of projecting portions includes at least one opening,
at least one of the projecting portions is divided into an inner region placed on the inner side in the tire radial-direction and an outer region placed on the outer side in the tire radial-direction with respect to a position of an outer end of the belt play in the tire width-direction, wherein the belt play placed on the innermost side in the tire radial-direction, and
the total sum of the opening area of the opening in the inner region is equal to or greater than the total sum of the opening area of the opening in the outer region.
